(19) United States
(12) Patent Application Publication
(10) Pub. No.: US 2020/0095415 A1
(43) Pub. Date: Mar. 26, 2020

(54) COMPOSITION COMPRISING A SEMI-CRYSTALLINE VDF POLYMER AND A FLUORINATED THERMOPLASTIC ELASTOMER BLOCK COPOLYMER

(71) Applicant: SOLVAY SPECIALTY POLYMERS ITALY S.P.A., Bollate (IT)

(72) Inventors: David McILROY, Johns Creek, GA (US); Keshav S. GAUTAM, Duluth, GA (US); Satchit SRINIVASAN, Dallas, TX (US)

(21) Appl. No.: 16/494,762

(22) PCT Filed: Mar. 13, 2018
(86) PCT No.: PCT/EP2018/056292

§ 371 Date: Sep. 16, 2019

Related U.S. Application Data
(60) Provisional application No. 62/471,138, filed on Mar. 14, 2017.

(51) Int. Cl. C08L 53/00; B29C 45/00

(52) U.S. Cl. CPC C08L 53/00; B29K 2027/16; C08L 2205/03; B29C 45/0001

(57) ABSTRACT

The invention pertains to a fluoropolymer composition based on a thermoplastic vinylidene fluoride (VDF) polymer and a thermoplastic fluorinated elastomer, possessing advantageous performances, including improved compromise between flexibility and stiffness, and suitable for being notably used in the manufacture of parts and accessories of mobile electronic devices, to a method of making the said composition, and to a method of manufacturing said parts from said composition and mobile electronic devices using said parts.

This application claims priority to U.S. provisional application No. U.S. 62/471,138 filed on Mar. 14, 2017, the whole content of this application being incorporated herein by reference for all purposes.

### TECHNICAL FIELD

The invention pertains to a fluoropolymer composition possessing advantageous performances, including improved compromise between flexibility and stiffness, and suitable for being notably used in the manufacture of parts and accessories of mobile electronic devices, to a method of making the said composition, and to a method of manufacturing said parts from said composition and mobile electronic devices using said parts.

### BACKGROUND ART

Nowadays, mobile electronic devices such as mobile phones, personal digital assistants (PDAs), laptop computers, MP3 players, heart rate monitors, and so on, are in widespread use around the world. Mobile electronic devices are getting smaller and lighter for even more portability and convenience, while at the same time becoming increasingly capable of performing more advanced functions and supplemental connected services and peripheral's, both due to the development of the devices and the network systems.

Wrist bands, chest belts and other affixtures have been developed for securing electronic devices to specific part of human body. Mostly, these are made from elastomeric polymeric materials. E.g. wrist bands have been already disclosed, for example, in EP 2468127 B (BIWI S.A.), which is directed to jewelry items made from compositions comprising an elastomeric matrix having dispersed therein reinforcing fillers selected from the group consisting of microfibers, polytetrafluoroethylene nanoparticles, and mixtures thereof; similarly, GB 2460890 (EVENTUAL LTD) discloses a band comprising a protective portion housing an electronic tag and a second portion forming a band to be worn by a person, wherein the band material may be an elastomeric material such as rubber, in particular silicone rubber, and the protective portion may be made of metal or nylon.

Further, signal transmission cables for transmitting/receiving electric signals generated in acoustic systems or imaging systems may be connected for use with earphones, headphones, speakers, or image display devices to portable electronics. All these cables have an outer sheath, which is also referred to as “cable jacket” or “outermost coating layer”, which encloses all the components of the cable and protects them from the external environment, while at the same time it provides easy handling, flexibility and mechanical strength. This type of cable has been disclosed for example in US 2014041897 (JOINSET CO. LTD.) and in US 2011051973 (TSINGHUA UNIVERSITY, HON HAI PRECISION INDUSTRY CO., LTD).

Further, solutions have been designed to protect portable electronic devices and withstand the rigors of frequent use, including drops and impacts, based on protective cases designed to receive and hold them.

Cases for portable electronic devices have been disclosed in several patents and patent applications, such as for example WO 2011/053740 (BENLKIN INTERNATION, INC.), WO 2013/043462 (SPECULATIVE PRODUCT DESIGN LLC), WO 2014/145262 (MAV IP LLC) and US 2015097009 (THULE ORGANIZATION SOLUTIONS INC). Cases for portable electronic devices are typically made from hydrogenated thermoplastic polyurethane polymers, because of their durability, rubber behaviour, and tear resistance, although solutions based on silicon rubbers or hydrocarbon rubbers have been also pursued.

While traditional headphones have relatively large ear cups, smaller headphones known as earbuds have been the solution of choice for playing audio for users of electronic devices. These earbuds have elastomeric earpieces, hosting a speaker that fits within a user's ear canal. These parts need be sufficiently durable to withstand rough handling, and yet possessing comfort in wearing, and obvious anti-stain performances.

While all these different parts, accessories and devices, generally connected to mobile electronics, as listed above, may be seen as disparate and un-connected, they share quite similar requirements for the materials used for their manufacture. Materials shall be easily processable into complex geometry parts, shall ensure electrical insulation/electrical shield among components, shall deliver outstanding durability and wear resistance, shall enable un-restricted aesthetic possibilities, thanks to their colorability, shall be endowed with outstanding weather/stain protection, and yet shall possess an outstanding mechanical properties/flexibility balance.

Further, while rubbers (e.g. silicone rubbers) have found use, they came with the drawbacks of their inherent thermoset character, hence making impossible typical easy thermoplasts processing, requiring prolonged cure times, and causing losses in scraps and trimmings, which cannot be re-processed.

Efforts for providing a material able to tackle all afore-mentioned requirements in this field of use are ongoing, and while solutions based on a variety of plastics have already been attempted, still continuous improvements to reach unmet challenges are required.

### SUMMARY OF INVENTION

Within this frame, the present invention aims at providing a solution based on a particular combination of fluorinated polymers, and more specifically, to a combination of certain fluorinated thermoplastic elastomer and certain thermoplastic fluoropolymer, to the aim of achieving a good stiffness/flexibility properties' compromise, yet maintaining all advantageous behaviour of fluorinated thermoplastic elastomers.

More specifically, the invention is directed, in a first aspect, to a fluoropolymer composition [composition (C)], said composition comprising
at least one thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418, and
(ii) at least one thermoplastic block (B) consisting of a sequence of recurring units, said sequence comprising recurring units derived from at least one fluorinated monomer, wherein the crystallinity of said block (B) and its weight fraction in the polymer (F-TPE) are such to provide for a heat of fusion (ΔH_{f}) of the polymer (F-TPE) of at most 20 J/g, when determined according to ASTM D3418;
at least one at least one thermoplastic vinylidene fluoride (VDF) polymer [polymer (F)] comprising recurring units derived from VDF in an amount of at least 85% moles, with respect to the total moles of recurring units of polymer (F), said polymer (F) possessing a heat of fusion (ΔH_{f}) of the polymer (F-TPE) of at least 25 J/g, when determined according to ASTM D3418; and optionally
at least one methyl methacrylate polymer [polymer (M)] in an amount of at most 25% wt,
the % wt being referred to the sum of weights of polymer (F), elastomer (F-TPE) and polymer (M).

The Applicant has surprisingly found that compositions (C), as above detailed, thanks to the combination of the properties of the polymer (F-TPE) and of polymer (F), as above detailed, are delivering a particularly advantageous combinations of properties which make them particularly adapted for the manufacture of different parts, accessories and devices, intended for use in connection with mobile electronic devices. In particular parts made from said composition (C) possess an outstanding balance of mechanical properties, durability and wear resistance, and elastomeric character which can easily tuned within the entire compositional range, depending on target use, thanks to the inter-mixing of polymer (F-TPE) and of polymer (F), as above detailed and simultaneously have improved resistance to staining, providing for un-matched aesthetic appearance even after prolonged use and exposure to typical staining agents of normal home-environment.

### DESCRIPTION OF EMBODIMENTS

The Fluorinated Thermoplastic Elastomer [Polymer (F-TPE)]

For the purpose of the present invention, the term “elastomeric”, when used in connection with the “block (A)” is hereby intended to denote a polymer chain segment which, when taken alone, is substantially amorphous, that is to say, has a heat of fusion of less than 2.0 J/g, preferably of less than 1.5 J/g, more preferably of less than 1.0 J/g, as measured according to ASTM D3418.

For the purpose of the present invention, the term “thermoplastic”, when used in connection with the “block (B)”, is hereby intended to denote a polymer chain segment which, when taken alone, is semi-crystalline, and possesses a detectable melting point, with an associated heat of fusion of exceeding 10.0 J/g, as measured according to ASTM D3418.

The fluorinated thermoplastic elastomer of the composition (C) of the invention is advantageously a block copolymer, said block copolymer typically having a structure comprising at least one block (A) alternated to at least one block (B), that is to say that said fluorinated thermoplastic elastomer typically comprises, preferably consists of, one or more repeating structures of type (B)-(A)-(B). Generally, the polymer (F-TPE) has a structure of type (B)-(A)-(B), i.e. comprising a central block (A) having two ends, connected at both ends to a side block (B).

The block (A) is often alternatively referred to as soft block (A); the block (B) is often alternatively referred to as hard block (B).

The term “fluorinated monomer” is hereby intended to denote an ethylenically unsaturated monomer comprising at least one fluorine atom.

The fluorinated monomer may further comprise one or more other halogen atoms (Cl, Br, I).

Any of block(s) (A) and (B) may further comprise recurring units derived from at least one hydrogenated monomer, wherein the term “hydrogenated monomer” is intended to denote an ethylenically unsaturated monomer comprising at least one hydrogen atom and free from fluorine atoms.

The elastomeric block (A) may further comprise recurring units derived from at least one bis-olefin [bis-olefin (OF)] of formula:

R_{A}R_{B}═CR_{C}-T-CR_{D}=R_{E}R_{F}

wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, preferably at least partially fluorinated, or a (per)fluoropolyoxyalkylene group.

The bis-olefin (OF) is preferably selected from the group consisting of those of any of formulae (OF-1), (OF-2) and (OF-3):

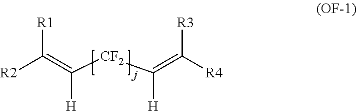

wherein j is an integer comprised between 2 and 10, preferably between 4 and 8, and R1, R2, R3 and R4, equal to or different from each other, are selected from the group consisting of H, F, C₁-C₅ alkyl groups and C₁-C₅ (per)fluoroalkyl groups;

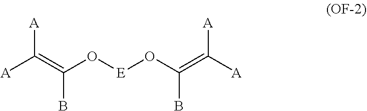

wherein each of A, equal to or different from each other and at each occurrence, is independently selected from the group consisting of H, F and Cl; each of B, equal to or different from each other and at each occurrence, is independently selected from the group consisting of H, F, Cl and OR_{B}, wherein R_{B} is a branched or straight chain alkyl group which may be partially, substantially or completely fluorinated or chlorinated, E is a divalent group having 2 to 10 carbon atoms, optionally fluorinated, which may be inserted with ether linkages; preferably E is a —(CF₂)ₘ— group, wherein m is an integer comprised between 3 and 5; a preferred bis-olefin of (OF-2) type is F₂C═CF—O—(CF₂)₅—O—CF═CF₂;

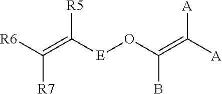

wherein E, A and B have the same meaning as defined above, R5, R6 and R7, equal to or different from each other, are selected from the group consisting of H, F, C₁-C₅ alkyl groups and C₁-C₅ (per)fluoroalkyl groups.

Should the block (A) consist of a recurring units sequence further comprising recurring units derived from at least one bis-olefin (OF), said sequence typically comprises recurring units derived from the said at least one bis-olefin (OF) in an amount comprised between 0.01% and 1.0% by moles, preferably between 0.03% and 0.5% by moles, more preferably between 0.05% and 0.2% by moles, based on the total moles of recurring units of block (A).

The polymer (F-TPE) typically comprises, preferably consists of:
at least one elastomeric block (A) selected from the group consisting of: (1) vinylidene fluoride (VDF)-based elastomeric blocks (A_{VDF}) consisting of a sequence of recurring units, said sequence comprising recurring units derived from VDF and recurring units derived from at least one fluorinated monomer different from VDF, said fluorinated monomer different from VDF being typically selected from the group consisting of:
(a) C₂-C₈ perfluoroolefins such as tetrafluoroethylene (TFE), hexafluoropropylene (HFP);
(b) hydrogen-containing C₂-C₈ fluoroolefins different from VDF, such as vinyl fluoride, trifluoroethylene (TrFE), hexafluoroisobutylene (HFIB), perfluoroalkyl ethylenes of formula CH₂═CH—R_{f1}, wherein R_{f1} is a C₁-C₆ perfluoroalkyl group;
(c) C₂-C₈ chloro- and/or bromo-containing fluoroolefins such as chlorotrifluoroethylene (CTFE);
(d) perfluoroalkylvinylethers (PAVE) of formula CF₂═CFOR_{f1}, wherein R_{f1} is a C₁-C₆ perfluoroalkyl group, such as CF₃ (PMVE), C₂F₅ or C₃F₇;
(e) perfluorooxyalkylvinylethers of formula CF₂═CFOX₀, wherein X₀ is a C₁-C₁₂ perfluorooxyalkyl group comprising one or more than one ethereal oxygen atom, including notably perfluoromethoxyalkylvinylethers of formula CF₂═CFOCF₂OR_{f2}, with R_{f2} being a C₁-C₃ perfluoro(oxy)alkyl group, such as —CF₂CF₃, —CF₂CF₂—O—CF₃ and —CF₃; and
(f) (per)fluorodioxoles of formula:

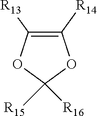

wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms, such as —CF₃, —C₂F₅, —C₃F₇, —OCF₃ or —OCF₂CF₂OCF₃; and
(2) tetrafluoroethylene (TFE)-based elastomeric blocks (A_{TFE}) consisting of a sequence of recurring units, said sequence comprising recurring units derived from TFE and recurring units derived from at least one fluorinated monomer different from TFE, said fluorinated monomer being typically selected from the group consisting of those of classes (b), (c), (d), (e) as defined above;
at least one thermoplastic block (B) consisting of a sequence of recurring, said sequence comprising recurring units derived from at least one fluorinated monomer.

Any of block(s) (A_{VDF}) and (A_{TFE}) may further comprise recurring units derived from at least one hydrogenated monomer, which may be selected from the group consisting of C₂-C₈ non-fluorinated olefins such as ethylene, propylene or isobutylene, and may further comprise recurring units derived from at least one bis-olefin (OF), as above detailed.

The elastomeric block (A) is preferably a block (A_{VDF}), as above detailed, said block (A_{VDF}) typically consisting of a sequence of recurring units comprising, preferably consisting of:
from 45% to 80% by moles of recurring units derived from vinylidene fluoride (VDF),
from 5% to 50% by moles of recurring units derived from at least one fluorinated monomer different from VDF,
optionally, up to 1.0% by moles of recurring units derived from at least one bis-olefin (OF), as above detailed; and
optionally, up to 30% by moles of recurring units derived from at least one hydrogenated monomer,
with respect to the total moles of recurring units of the sequence of block (A_{VDF}).

Block (B) may consist of a sequence of recurring units, said sequence comprising:
recurring units derived from one or more than one fluoromonomer, preferably selected from the group consisting of:
(a) C₂-C₈ perfluoroolefins such as tetrafluoroethylene (TFE), hexafluoropropylene (HFP);
(b) hydrogen-containing C₂-C₈ fluoroolefins, such as vinylidene fluoride (VDF), vinyl fluoride, trifluoroethylene (TrFE), hexafluoroisobutylene (HFIB), perfluoroalkyl ethylenes of formula CH₂═CH—R_{f1}, wherein R_{f1} is a C₁-C₆ perfluoroalkyl group;
(c) C₂-C₈ chloro- and/or bromo-containing fluoroolefins such as chlorotrifluoroethylene (CTFE);
(d) perfluoroalkylvinylethers (PAVE) of formula CF₂═CFOR_{f1}, wherein R_{f1} is a C₁-C₆ perfluoroalkyl group, such as CF₃ (PMVE), C₂F₅ or C₃F₇;
(e) perfluorooxyalkylvinylethers of formula CF₂═CFOX₀, wherein X₀ is a C₁-C₁₂ perfluorooxyalkyl group comprising one or more than one ethereal oxygen atom, including notably perfluoromethoxyalkylvinylethers of formula CF₂═CFOCF₂OR_{f2}, with R_{f2} being a C₁-C₃ perfluoro(oxy)alkyl group, such as —CF₂CF₃, —CF₂CF₂—O—CF₃ and —CF₃; and
(f) (per)fluorodioxoles of formula:

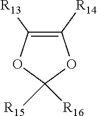

wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms, such as —CF₃, —C₂F₅, —C₃F₇, —OCF₃ or —OCF₂CF₂OCF₃; and
optionally, recurring units derived from one or more than one hydrogenated monomer, as above detailed, including notably ethylene, propylene, (meth)acrylic monomers, styrenic monomers.

More specifically, block (B) may be selected from the group consisting of:
blocks (B_{VDF}) consisting of a sequence of recurring units derived from vinylidene fluoride and optionally from one or more than one additional fluorinated monomer different from VDF, e.g. HFP, TFE or CTFE, and optionally from a hydrogenated monomer, as above detailed, e.g. a (meth)acrylic monomer, whereas the amount of recurring units derived from VDF is of 85 to 100% moles, based on the total moles of recurring units of block (B_{VDF});
blocks (B_{TFE}) consisting of a sequence of recurring units derived from tetrafluoroethylene, and optionally from an additional perfluorinated monomer different from TFE, whereas the amount of recurring units derived from TFE is of 75 to 100% moles, based on the total moles of recurring units of block (B);
blocks (B_{E/(C)TFE}) consisting of a sequence of recurring units derived from ethylene and recurring units derived from CTFE and/or TFE, possibly in combination with an additional monomer.

The weight ratio between blocks (A) and blocks (B) in the fluorinated thermoplastic elastomer is typically comprised between 95:5 and 10:90.

According to certain preferred embodiments, the polymers (F-TPE) comprise a major amount of blocks (A); according to these embodiment's, the polymer (F-TPE) used in the method of the present invention is characterized by a weight ratio between blocks (A) and blocks (B) of 95:5 to 65:35, preferably 90:10 to 70:30.

The crystallinity of block (B) and its weight fraction in the polymer (F-TPE) are such to provide for a heat of fusion (ΔH_{f}) of the polymer (F-TPE) of at most 20 J/g, preferably at most 18 J/g, more preferably at most 15 J/g, when determined according to ASTM D3418; on the other side, polymer (F-TPE) combines thermoplastic and elastomeric character, so as to possess a certain crystallinity, delivering a heat of fusion of at least 2.5 J/g, preferably at least 3.0 J/g.

Preferred polymers (F-TPE) are those comprising:
at least one elastomeric block (A_{VDF}), as above detailed, and
at least one thermoplastic block (B_{VDF}), as above detailed, and wherein the crystallinity of said block (B) and its weight fraction in the polymer (F-TPE) are such to provide for a heat of fusion of the polymer (F-TPE) of at most 15 J/g, when determined according to ASTM D3418.

The Polymer (F)

The expression vinylidene fluoride polymer and polymer (F) are used within the frame of the present invention for designating polymers essentially made of recurring units, more that 85% by moles of said recurring units being derived from vinylidene fluoride (VDF).

Polymer (F) has a substantial crystalline character, and possesses a heat of fusion (ΔH_{f}) of more than 25 J/g, preferably of more than 27 J/g, more preferably more than 30 J/g, when determined according to ASTM D3418.

The vinylidene fluoride polymer [polymer (F)] is preferably a polymer comprising:
(a′) at least 85% by moles of recurring units derived from vinylidene fluoride (VDF);
(b′) optionally from 0.1 to 15%, preferably from 0.1 to 12%, more preferably from 0.1 to 10% by moles of recurring units derived from a fluorinated monomer different from VDF; and
(c′) optionally from 0.1 to 5%, by moles, preferably 0.1 to 3% by moles, more preferably 0.1 to 1% by moles of recurring units derived from one or more hydrogenated comonomer(s),
all the aforementioned % by moles being referred to the total moles of recurring units of the polymer (F).

The said fluorinated monomer is advantageously selected in the group consisting of vinyl fluoride (VF₁); trifluoroethylene (VF₃); chlorotrifluoroethylene (CTFE); 1,2-difluoroethylene; tetrafluoroethylene (TFE); hexafluoropropylene (HFP); perfluoro(alkyl)vinyl ethers, such as perfluoro(methyl)vinyl ether (PMVE), perfluoro(ethyl) vinyl ether (PEVE) and perfluoro(propyl)vinyl ether (PPVE); perfluoro(1,3-dioxole); perfluoro(2,2-dimethyl-1,3-dioxole) (PDD). Preferably, the possible additional fluorinated monomer is chosen from chlorotrifluoroethylene (CTFE), hexafluoroproylene (HFP), trifluoroethylene (VF3) and tetrafluoroethylene (TFE).

The choice of the said hydrogenated comonomer(s) is not particularly limited; alpha-olefins, (meth)acrylic monomers, vinyl ether monomers, styrenic mononomers may be used; nevertheless, to the sake of optimizing chemical resistance, embodiment's wherein the polymer (F) is essentially free from recurring units derived from said hydrogenated comonomer(s) are preferred.

Accordingly, the vinylidene fluoride polymer [polymer (F)] is more preferably a polymer consisting essentially of:
(a′) at least 85% by moles of recurring units derived from vinylidene fluoride (VDF);
(b′) optionally from 0.1 to 15%, preferably from 0.1 to 12%, more preferably from 0.1 to 10% by moles of a fluorinated monomer different from VDF; said fluorinated monomer being preferably selected in the group consisting of vinylfluoride (VF₁), chlorotrifluoroethylene (CTFE), hexafluoropropene (HFP), tetrafluoroethylene (TFE), perfluoromethylvinylether (MVE), trifluoroethylene (TrFE) and mixtures therefrom,
all the aforementioned % by moles being referred to the total moles of recurring units of the polymer (F).

Defects, end chains, impurities, chains inversions or branchings and the like may be additionally present in the polymer (F) in addition to the said recurring units, without these components substantially modifying the behaviour and properties of the polymer (F).

As non-limitative examples of polymers (F) useful in the present invention, mention can be notably made of homopolymers of VDF, VDF/TFE copolymers, VDF/TFE/HFP copolymers, VDF/TFE/CTFE copolymers, VDF/TFE/TrFE copolymers, VDF/CTFE copolymers, VDF/HFP copolymers, VDF/TFE/HFP/CTFE copolymers and the like.

VDF homopolymers are particularly advantageous for being used as polymer (F) in the composition (C).

The melt index of the polymer (F) is advantageously at least 0.01, preferably at least 0.05, more preferably at least 0.1 g/10 min and advantageously less than 50, preferably less than 30, more preferably less than 20 g/10 min, when measured in accordance with ASTM test No. 1238, run at 230° C., under a piston load of 2.16 kg.

The melt index of the polymer (F) is advantageously at least 1, preferably at least 2, more preferably at least 5 g/10 min and advantageously less than 70, preferably less than 50, more preferably less than 40 g/10 min, when measured in accordance with ASTM test No. 1238, run at 230° C., under a piston load of 5 kg.

The polymer (F) has advantageously a melting point (Tₘ₂) advantageously of at least 120° C., preferably at least 125° C., more preferably at least 130° C. and of at most 190° C., preferably at most 185° C., more preferably at most 180° C., when determined by DSC, at a heating rate of 10° C./min, according to ASTM D 3418.

The Polymer (M)

With regard to the expressions “methyl methacrylate polymer” or “polymer (M)”, these terms are hereby used to denote methyl methacrylate homopolymers and methyl methacrylate copolymers which have a preponderant content of methyl methacrylate and a minor content of other monomers selected from alkyl(meth)acrylates, acrylonitrile, butadiene, styrene and isoprene.

Advantageous results are obtained with homopolymers of methyl methacrylate and copolymers of methyl methacrylate and of C₂-C₆ alkyl acrylates. Outstanding results are obtained with homopolymers of methyl methacrylate and copolymers of methyl methacrylate and of C₂-C₄ alkyl acrylates such as, for example, butyl acrylate. The methyl methacrylate content of the copolymers is generally at least approximately 55% by weight and preferably at least approximately 60% by weight. It generally does not exceed approximately 90% by weight; in most cases it does not exceed 80% by weight, with respect to the total weight of polymer (M).

Advantageously, the polymer (M) may contain 0 to 20 percent and preferably 5 to 15 percent of at least one of methyl acrylate, ethyl acrylate and butyl acrylate, by weight of polymer (M).

The polymer (M) may be functionalised, that is to say it contains, for example, acid, acid chloride, alcohol or anhydride functional groups. These functional groups may be introduced by grafting or by copolymerisation. Advantageously, this is an acid functional group provided by the acrylic acid comonomer. Two neighbouring acrylic acid functional groups may lose water to form an anhydride. The proportion of functional groups may be between 0 and 15 percent by weight of the polymer (M) containing the optional functional groups.

The polymer (M) has advantageously a glass transition temperature of at least 80° C., preferably of at least 85° C., more preferably of at least 100° C., when measured according to according to ASTM D 3418.

According to certain preferred embodiments, the polymer (M) is polymethylmethacrylate homopolymer.

The Composition (C)

The composition (C) comprises polymer (F-TPE) as predominant component, that is to say that the amount of polymer (F-TPE) in the composition (C) is generally of at least 50% wt, preferably at least 60% wt, most preferably of at least 70% wt; and/or is advantageously of at most 97% wt, preferably at most 95% wt, more preferably at most 94% wt, with respect to the total weight of polymer (F), polymer (F-TPE) and polymer (M).

The amount of polymer (F) in the composition (C) is of at least 3% wt, preferably of at least 5% wt, more preferably at least 6% wt; and/or is of at most 50% wt, preferably at most 40% wt, more preferably at most 30% wt, with respect to the total weight of polymer (F), polymer (F-TPE) and polymer (M).

While, as explained, the presence of polymer (M) in the composition (C) is not mandatory, that is to say its amount may be zero, upper boundaries for the amount of polymer (M) are generally as hereafter defined: the amount of polymer (M) in the composition (C) is generally of at most 25% wt, preferably at most 20% wt, more preferably at most 15% wt, with respect to the total weight of polymer (F), polymer (F-TPE) and polymer (M).

According to certain embodiment's, the composition (C) does not comprise any polymer (M) as above detailed. According to these embodiment's, the preferred composition (C) comprises:
from 50 to 97% wt, preferably from 60 to 95% wt, more preferably from 70 to 94% wt of polymer (F-TPE) and
from 3 to 50% wt, preferably from 5 to 40% wt, more preferably from 6 to 30% wt of polymer (F),
wherein % wt is defined with respect to the total weight of polymer (F-TPE) and polymer (F).

According to certain other embodiment's, polymer (M) is present in the composition. According to these embodiment's, the preferred composition (C) comprises:
from 50 to 96% wt, preferably from 60 to 92% wt, more preferably from 70 to 89% wt of polymer (F-TPE);
from 3 to 45% wt, preferably from 5 to 35% wt, more preferably from 6 to 25% wt of polymer (F); and
from 1 to 25% wt, preferably from 3 to 20% wt, more preferably from 5 to 15% wt of polymer (M),
with respect to the total weight of polymer (F), polymer (F-TPE) and polymer (M).

The composition (C) may further comprise, in addition to polymer (F), polymer (F-TPE), and possibly polymer (M), one or more additives, notably one or more additives selected from the group consisting of pigments, processing aids, plasticizers, stabilizers, mold release agents, and the like.

When present, additives are generally comprised in the composition (C) in amounts not exceeding 10 parts, preferably not exceeding 5 parts per 100 weight parts of polymer (F), polymer (F-TPE) and polymer (M).

Preferred embodiments are those wherein the composition (C) consists of polymer (F), polymer (F-TPE), polymer (M) and optionally from 0 to 10 weight parts, per 100 weight parts of polymer (F), polymer (F-TPE) and polymer (M), of one or more than one additive.

To the sake of aesthetic appearance is generally understood that the composition will comprise at least one additive selected from pigments.

Pigments useful in composition (C) are generally selected among oxides, sulfides, oxides hydroxides, silicates, sulfates, titanates, phosphates, carbonates and mixtures thereof.

White inorganic pigments are preferred in the composition (C) when aiming at providing white parts.

Among white pigments suitable for the composition of the invention mention can be made of TiO₂ pigments (e.g. rutile, anatase), Zinc oxide (ZnO) pigments (e.g. Zinc white, Chinese white or flowers of Zinc), Zinc sulphide (ZnS) pigments, lithopone (mixed pigment produced from Zinc sulphide and barium sulphate) pigments, white lead pigments (basic lead carbonate), Barium sulphate, and corresponding complex pigments obtained from coating of above mentioned pigments on suitable inorganic carriers, e.g. silicates, alumino-silicates, mica and the like.

Particularly preferred pigments are Zinc oxide and Zinc sulphide pigments, which have been shown to produce, when incorporated in the composition (C) moulded parts possessing outstanding whiteness.

As said above, it may be appropriate, in certain cases, to add minor amounts of coloured pigments in combination with any of the white pigment mentioned above, so as to tune colour coordinate towards a target white colour, and/or for reducing yellowness or for any other reason.

Coloured pigments useful in the composition (C) notably include, or will comprise, one or more of the following: Artic blue #3, Topaz blue #9, Olympic blue #190, Kingfisher blue #211, Ensign blue #214, Russet brown #24, Walnut brown #10, Golden brown #19, Chocolate brown #20, Ironstone brown #39, Honey yellow #29, Sherwood green #5, and Jet black #1 available from Shepard Color Company, Cincinnati, Ohio, USA; black F-2302, blue V-5200, turquoise F-5686, green F-5687, brown F-6109, buff F-6115, chestnut brown V-9186, and yellow V-9404 available from Ferro Corp., Cleveland, Ohio, USA and METEOR® pigments available from Englehard Industries, Edison, N.J., USA; ultramarine blue #54, ultramarine violet #5012, commercially available from Hollidays Pigments International.

Within this context, hence, preferred embodiments are those wherein the composition (C) consists of polymer (F), polymer (F-TPE), polymer (M) and from 0.01 to 10 weight parts, per 100 weight parts of polymer (F), polymer (F-TPE), polymer (M), of one or more than one additive, at least one of said additives being a pigment, as above detailed, said at least one pigment being used in an amount of from 0.01 to 5, preferably of from 0.01 to 3 weight parts, per 100 weight parts of polymer (F), polymer (F-TPE), and polymer (M).

The invention further pertains to a method of making the composition (C), as above detailed.

The method advantageously generally includes at least one step of mixing polymer (F), polymer (F-TPE), and possibly polymer (M). Mixing can be effected using standard mixing devices; generally polymer (F), polymer (F-TPE) and polymer (M) (when present) are mixed in the molten form; nevertheless, methods wherein polymer (F), polymer (F-TPE) and polymer (M) (when present) are mixed under the form of latexes and then co-coagulated and/or methods wherein polymer (F), polymer (F-TPE) and polymer (M) (when present) are mixed as solutions in appropriate solvent or as powders can also be practiced.

Mixing in the molten state is generally accomplished using extruder devices, with twin-screw extruders being preferred.

It is hence common practice of manufacturing the composition (C) under the form of pellets.

The composition (C) can be moulded to provide a shaped part. Technique used for moulding is not particularly limited; standard techniques including shaping composition (C) in a molten/softened form can be advantageously applied, and include notably compression moulding, extrusion moulding, injection moulding, transfer moulding and the like.

A method of making a shaped part, said method comprising moulding composition (C), as above detailed, is yet another embodiment of the invention.

It is nevertheless generally understood that especially when said shaped part possesses a complex design, injection moulding technique is the most versatile, and extensively used.

According to this technique, a ram or screw-type plunger is used for forcing a portion of composition (C) in its molten state into a mould cavity, wherein the same solidified into a shape that has confirmed to the contour of the mould. Then, the mould opens and suitable means (e.g. an array of pins, sleeves, strippers, etc.) are driven forward to demould the article. Then, the mould closes and the process is repeated.

In another embodiment of the present invention, a step of machining a standard shaped article made from composition (C) so as to obtain said part having different size and shape from said standard shaped article can be used. Non limiting examples of said standard shaped articles include notably a plate, a rod, a slab and the like. Said standard shaped parts can be obtained by any processing technique, including notably extrusion or injection moulding of the polymer composition (C).

Yet, especially when the target shaped part is a coated conductor wire or a bundle of conductor wires, composition (C) may be shaped in the form of a sheath or a jacket through extrusion techniques.

Whichever the processing technology, it is nevertheless understood that the overall thermoplast character of the composition (C) enables recycling and re-processing scraps and trimmings.

On the other side, embodiment's whereas the shaped part is submitted to conditions causing at least partial curing or crosslinking of the composition (C) are yet encompassed.

Yet other objects of the present invention are shaped parts made from the composition (C) of the present invention. Shaped parts of the invention are advantageously components of different peripheral's, accessories and devices, intended for connection to mobile electronic devices.

The said shaped parts can be notably wrist bands, chest belts and other affixtures have been developed for securing electronic devices to specific part of human body.

The said shaped parts may be components of signal transmission cables, e.g. for transmitting/receiving electric signals generated in acoustic systems or imaging systems, which may be connected for use with earphones, headphones, speakers, or image display devices to portable electronics. Said shaped part can be notably a cable jacket or an outermost coating layer of the said signal transmission cables, which advantageously encloses all the components of the cable and protects them from the external environment, while at the same time it provides easy handling, flexibility and mechanical strength.

Yet, the shaped part may be a protective case designed to receive and hold a portable electronic device.

Still, the shaped part may be a component of an earbud, including those intended to be connected to portable electronic devices.

Should the disclosure of any patents, patent applications, and publications which are incorporated herein by reference conflict with the description of the present application to the extent that it may render a term unclear, the present description shall take precedence.

The invention will now be described with reference to the following examples, whose purpose is merely illustrative and not intended to limit the scope of the invention.

Raw Materials

SOLEF® 6008/0001 PVDF is a low-viscosity PVDF homopolymer having a melt flow rate (at 230° C./2.16 kg, ASTM D1238) of about 5.5 to 11 g/10 min, a melt flow rate (230° C./5 kg) of 16 to 30 g/10 min, a heat of fusion (ΔH_{f}) of about 63 J/g, commercially available from Solvay Specialty Polymers (6008, herein after).

OPTIX® CA51 PMMA is a polymethylmethacrylate homopolymer having a melt from rate (230° C./3.8 kg, ASTM D1238) of about 15.0 g/10 min, commercially available from Plaskolite, Inc (CA51, herein after).

SACHTOLITH® HD-S white pigment is synthetic micronized ZnS (ZnS: >98% wt, primarily of polycrystalline wurtzite form of ZnS), organically coated; it is commercially available from Sachtleben Chemie GmbH (ZnS, herein after).

### PREPARATIVE EXAMPLE

### Preparative Example 1: Manufacture of Polymer F-TPE-1

PVDF-P(VDF-HFP)-PVDF (P(VDF-HFP) VDF: 78.5% by moles, HFP: 21.5% by moles) In a 7.5 liters reactor equipped with a mechanical stirrer operating at 72 rpm, 4.5 l of demineralized water and 22 ml of a microemulsion, previously obtained by mixing 4.8 ml of a perfluoropolyoxyalkylene having acidic end groups of formula CF₂ClO(CF₂—CF(CF₃)O)ₙ(CF₂O)ₘCF₂COOH, wherein n/m=10, having an average molecular weight of 600, 3.1 ml of a 30% v/v NH₄OH aqueous solution, 11.0 ml of demineralized water and 3.0 ml of GALDEN® D02 perfluoropolyether of formula CF₃O(CF₂CF(CF₃)O)ₙ(CF₂O)ₘCF₃, wherein n/m=20, having an average molecular weight of 450, were introduced.

The reactor was heated and maintained at a set-point temperature of 85° C.; a mixture of vinylidene fluoride (VDF) (78.5% by moles) and hexafluoropropylene (HFP) (21.5% by moles) was then added to reach a final pressure of 20 bar. Then, 8 g of 1,4-diiodoperfluorobutane (C₄F₈I₂) as chain transfer agent were introduced, and 1.25 g of ammonium persulfate (APS) as initiator were introduced. Pressure was maintained at a set-point of 20 bar by continuous feeding of a gaseous mixture of vinylidene fluoride (VDF) (78.5% by moles) and hexafluoropropylene (HFP) (21.5% by moles) up to a total of 2000 g. Moreover, 0.86 g of CH₂═CH—(CF₂)₆—CH═CH₂, fed in 20 equivalent portions each 5% increase in conversion, were introduced.

Once 2000 g of monomer mixture were fed to the reactor, the reaction was discontinued by cooling the reactor to room temperature. The residual pressure was then discharged and the temperature brought to 80° C. VDF was then fed into the autoclave up to a pressure of 20 bar, and 0.14 g of ammonium persulfate (APS) as initiator were introduced. Pressure was maintained at a set-point of 20 bar by continuous feeding of VDF up to a total of 500 g. Then, the reactor was cooled, vented and the latex recovered. The latex was treated with aluminum sulphate, separated from the aqueous phase, washed with demineralized water and dried in a convection oven at 90° C. for 16 hours.

Characterization data of the polymer so obtained are reported in Table 1.

TABLE 1

| | |
|---|---|
| DSC | Prep. Ex. 1 |

| | | |
|---|---|---|
| T_{g} | [° C.] | −21.5 |
| Tₘ | [° C.] | 162.5 |
| ΔH_{f} | [J/g] | 8.6 |

| | | |
|---|---|---|
| | | hard |
| Composition - NMR | soft (A) | (B) |

| | | | |
|---|---|---|---|
| VDF | [% mol] | 78.5 | 100 |
| HFP | [% mol] | 21.5 | — |

General Procedure for Preparation of Compositions for the Manufacture of Injection Moulding Parts

The ingredients, as detailed in Table 2, were compounded using a ZSK30 twin extruder, so as to obtain pellets, by extruding at a temperature of about 200° C., with a screw speed of 200 rpm at a throughput of 15 kg/h.

TABLE 2

| | Ex. 1C | Ex. 2 | Ex. 3 | Ex. 4 |
|---|---|---|---|---|
| F-TPE-1 | 100 | 92.5 | 75 | 75 |
| 6008 | — | 7.5 | 15 | 25 |
| CA51 | — | — | 10 | — |

General Procedure for Injection Moulding of Parts

Pellets as obtained by extrusion were fed to a Toshiba ISG-150 N injection molding device for the manufacture of injected parts having ASTM tensile bar shape, according to ASTM D638 and ASTM D790. The injection molding device used is equipped with a screw extruder barrel and a mould with clamping force up to 1000 kN, and melt pressure controller up to 2500 bar.

Injection molding conditions were such that melt temperature was about 180-210° C., and mold temperature was set to 35° C.

Properties of Injection Molded Specimens—Mechanical Properties

Injection molded specimens were tested for their tensile strength (according to ASTM D638). Results are summarized in table below.

TABLE 3

| Tensile | | | | |
|---|---|---|---|---|
| properties | Ex. 1C | Ex. 2 | Ex. 3 | Ex. 4 |
| Elasticity | 12.3 | 44.1 | 106.9 | 196.5 |
| Modulus (MPa) | | | | |
| Tensile Strain | 410 | 350 | 320 | 290 |
| at Break (%) | | | | |
| Tensile | 8.1 | 10.7 | 13.7 | 14.6 |
| Strength at | | | | |
| Break (MPa) | | | | |
| Tensile | 8.1 | 10.7 | 13.8 | 14.7 |
| Strength at | | | | |
| Yield (MPa) | | | | |

Properties of Injection Molded Specimens—Flexural Properties

Injection molded specimens were tested for their flexural properties (according to ASTM D790). Results are summarized in table below.

TABLE 4

| Flexural | | | | |
|---|---|---|---|---|
| properties | Ex. 1C | Ex. 2 | Ex. 3 | Ex. 4 |
| Flexural | 19.8 | 54.6 | 117.2 | 195.8 |
| Elasticity | | | | |
| Modulus (MPa) | | | | |
| Flexural Stress | 1.0 | 2.2 | 4.4 | 7.4 |
| at 5% strain | | | | |
| (MPa) | | | | |

Properties of Injection Molded Specimens—Abrasion Resistance

The specimens obtained as above detailed were submitted to tests aimed at determining their resistance to abrasion, using a wearaser equipment, operating under a load of 1000 g, a cycle speed of 30 cycles/minutes, with a stroke of 1 cm. Results summarized below provide for weight loss and height losses after 100 cycles.

TABLE 5

| | Ex. 1C | Ex. 2 | Ex. 3 | Ex. 4 |
|---|---|---|---|---|
| Weight Loss | 0.025 | 0.008 | 0.008 | 0.155 |
| (%) | | | | |
| Height Loss (%) | 1.13 | 0.388 | 0.400 | 0.743 |

Properties of Injection Molded Specimens—Colour/Stain Resistance

As-molded color of molded specimens was measured to assess the whiteness of the injection molded parts, when applying day-light type standard incident light (D65). The colour was measured according to the CIE L-a-b coordinates standard where the L* coordinate represents the lightness (black to white) scale, the a* coordinate represents the green-red chromaticity and the b* scale represents the blue-yellow chromaticity, and according to the CIE L-C-h coordinates standard, where the L* is as above in the CIE L-a-b standard, C* represents chroma, and h is the hue angle. The color coordinates were determined on the specimens as originally obtained, and on the same after exposure to certain staining agents (ketchup, mustard, sunscreen, sebum, wet denim), and cleaning up according to standardized procedure.

TABLE 6

| | | | | | |
|---|---|---|---|---|---|
| Run | L* | a* | b* | C* | h* |

CIE L-a-b & CIE L-C-h values/original

| | | | | | |
|---|---|---|---|---|---|
| Ex. 1C | 57.54 | 4.32 | 30.91 | 31.21 | 82.04 |
| Ex. 2 | 55.38 | 4.57 | 22.77 | 23.22 | 78.66 |
| Ex. 3 | 59.2 | 2.57 | 12.76 | 13.02 | 78.6 |
| Ex. 4 | 69.68 | −0.67 | 2.48 | 2.56 | 105.2 |

after ketchup staining and cleaning up

| | | | | | |
|---|---|---|---|---|---|
| Ex. 1C | 54.35 | 4.37 | 29.5 | 29.83 | 81.57 |
| Ex. 2 | 53.68 | 4.7 | 21.24 | 21.75 | 77.52 |
| Ex. 3 | 59.26 | 2.04 | 11.46 | 11.64 | 79.92 |
| Ex. 4 | 71.45 | −0.96 | 3.82 | 3.93 | 104.1 |

after mustard staining and cleaning up

| | | | | | |
|---|---|---|---|---|---|
| Ex. 1C | 55.04 | 4.41 | 30.7 | 31.01 | 81.83 |
| Ex. 2 | 54.74 | 4.37 | 22.83 | 23.24 | 79.16 |
| Ex. 3 | 59.12 | 1.63 | 14.72 | 14.81 | 83.67 |
| Ex. 4 | 69.46 | −3.02 | 9.38 | 9.86 | 107.9 |

after sunscreen staining and cleaning up

| | | | | | |
|---|---|---|---|---|---|
| Ex. 1C | 56.03 | 4.32 | 28.53 | 28.85 | 81.38 |
| Ex. 2 | 54.83 | 4.47 | 20.36 | 20.85 | 77.62 |
| Ex. 3 | 59.57 | 2.32 | 10.65 | 10.9 | 77.7 |
| Ex. 4 | 70.29 | −0.67 | 2.44 | 2.53 | 105.3 |

after sebum staining and cleaning up

| | | | | | |
|---|---|---|---|---|---|
| Ex. 1C | 55.45 | 4.43 | 29.87 | 30.2 | 81.56 |
| Ex. 2 | 54.83 | 4.75 | 21.27 | 21.79 | 77.41 |
| Ex. 3 | 59.22 | 2.41 | 11.64 | 11.89 | 78.32 |
| Ex. 4 | 68.45 | −0.64 | 1.42 | 1.55 | 114.2 |

after wet denim staining and cleaning up

| | | | | | |
|---|---|---|---|---|---|
| Ex. 1C | 50.76 | 2.63 | 25.28 | 25.41 | 84.05 |
| Ex. 2 | 49.53 | 3.79 | 18.75 | 19.13 | 78.56 |
| Ex. 3 | 54.29 | 1.72 | 9.23 | 9.39 | 79.43 |
| Ex. 4 | 67.65 | −2.23 | −2.2 | 3.14 | 224.6 |

Same results regarding resistance to staining agents are expressed in table herein below as differences of values of singular coordinates after and before staining test (ΔL*, Δa*, Δb*, ΔC* and Δh*), and as ΔE and Δ94, whereas ΔE [ΔE=((ΔL*)²+(Δa*)²+(Δb*)²)^{1/2}] and Δ94 [Δ94=((ΔL*)²+(ΔC*)²+(Δh*)²)^{1/2}] are the distance in the respective color coordinates space.

TABLE 7

| | | | | | | | |
|---|---|---|---|---|---|---|---|
| Run | ΔL* | Δa* | Δb* | ΔC* | Δh* | ΔE | Δ94 |

CIE L-a-b & CIE L-C-h values/ketchup

| | | | | | | | |
|---|---|---|---|---|---|---|---|
| Ex. 1C | −3.19 | 0.05 | −1.41 | −1.39 | −0.25 | 3.49 | 1.7 |
| Ex. 2 | −1.7 | 0.13 | −1.53 | −1.47 | −0.45 | 2.3 | 1.16 |
| Ex. 3 | 0.06 | −0.54 | −1.3 | −1.38 | 0.28 | 1.41 | 0.9 |
| Ex. 4 | 1.77 | −0.29 | 1.34 | 1.37 | −0.06 | 2.24 | 1.51 |

CIE L-a-b & CIE L-C-h values/mustard

| | | | | | | | |
|---|---|---|---|---|---|---|---|
| Ex. 1C | −2.5 | 0.08 | −0.22 | −0.2 | −0.11 | 2.51 | 1.25 |
| Ex. 2 | −0.65 | −0.19 | 0.06 | 0.02 | 0.2 | 0.68 | 0.36 |
| Ex. 3 | −0.07 | −0.94 | 1.96 | 1.79 | 1.23 | 2.18 | 1.53 |
| Ex. 4 | −0.21 | −2.35 | 6.9 | 7.29 | 0.24 | 7.3 | 6.54 |

CIE L-a-b & CIE L-C-h values/sunscreen

| | | | | | | | |
|---|---|---|---|---|---|---|---|
| Ex. 1C | −1.51 | 0 | −2.39 | −2.36 | −0.34 | 2.82 | 1.26 |
| Ex. 2 | −0.55 | −0.1 | −2.41 | −2.38 | −0.4 | 2.47 | 1.23 |
| Ex. 3 | 0.37 | −0.25 | −2.12 | −2.13 | −0.19 | 2.17 | 1.36 |
| Ex. 4 | 0.61 | 0 | −0.03 | −0.03 | 0.001 | 0.61 | 0.31 |

CIE L-a-b & CIE L-C-h values/sebum

| | | | | | | | |
|---|---|---|---|---|---|---|---|
| Ex. 1C | −2.09 | 0.11 | −1.04 | −1.02 | −0.26 | 2.34 | 1.14 |
| Ex. 2 | −0.56 | 0.18 | −1.5 | −1.43 | −0.49 | 1.61 | 0.84 |
| Ex. 3 | 0.02 | −0.17 | −1.12 | −1.13 | −0.06 | 1.13 | 0.72 |
| Ex. 4 | 0.61 | 0 | −0.03 | −0.03 | 0.01 | 0.61 | 0.31 |

CIE L-a-b & CIE L-C-h values/wet denim

| | | | | | | | |
|---|---|---|---|---|---|---|---|
| Ex. 1C | −4.97 | −1.54 | −4.91 | −5.06 | 0.93 | 7.15 | 3.34 |
| Ex. 2 | −3.31 | −1.32 | −5.23 | −5.38 | 0.22 | 6.32 | 3.05 |
| Ex. 3 | −0.53 | −1.27 | −3.77 | −3.95 | 0.46 | 4.02 | 2.51 |
| Ex. 4 | −1.02 | −1.43 | −4.72 | 0.49 | 4.91 | 5.04 | 4.77 |

All data comprised above clearly demonstrate the surprising effect that stain resistance is improved when adding to the fluorinated thermoplastic elastomer the vinylidene fluoride, with lower distances in color space (both in terms of ΔE and Δ94) after exposure to the above-listed large variety of staining agents, representative of common agents which mobile electronics and accessories thereof maybe exposed to, during their daily use, even in combination with PMMA, mitigating or off-setting the sensitivity of the same to certain staining agents.

1. A method of making a shaped part comprising injection molding a fluoropolymer composition (C) [composition (C)], said composition comprising:
at least one thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418, and
(ii) at least one thermoplastic block (B) consisting of a sequence of recurring units, said sequence comprising recurring units derived from at least one fluorinated monomer, wherein the crystallinity of said block (B) and its weight fraction in the polymer (F-TPE) are such to provide for a heat of fusion (ΔH_{f}) of the polymer (F-TPE) of at most 20 J/g, when determined according to ASTM D3418, said polymer (F-TPE) being in an amount of at least 50% wt;
at least one at least one thermoplastic vinylidene fluoride (VDF) polymer [polymer (F)] comprising recurring units derived from VDF in an amount of at least 85% moles, with respect to the total moles of recurring units of polymer (F), said polymer (F) possessing a heat of fusion (ΔH_{f}) of the polymer (F-TPE) of at least 25 J/g, when determined according to ASTM D3418; and optionally
at least one methyl methacrylate polymer [polymer (M)] in an amount of at most 25% wt, the % wt being referred to the sum of weights of polymer (F), elastomer (F-TPE) and polymer (M).

2. The method of claim 1, wherein the polymer (F-TPE) comprises:
at least one elastomeric block (A) selected from the group consisting of:
(1) vinylidene fluoride (VDF)-based elastomeric blocks (A_{VDF}) consisting of a sequence of recurring units, said sequence comprising recurring units derived from VDF and recurring units derived from at least one fluorinated monomer different from VDF, said fluorinated monomer different from VDF being selected from the group consisting of:
(a) C₂-C₈ perfluoroolefins;
(b) hydrogen-containing C₂-C₈ fluoroolefins different from VDF;
(c) C₂-C₈ chloro- and/or bromo-containing fluoroolefins;
(d) perfluoroalkylvinylethers (PAVE) of formula CF₂═CFOR_{f1}, wherein R_{f1} is a C₁-C₆ perfluoroalkyl group;
(e) perfluorooxyalkylvinylethers of formula CF₂═CFOX₀, wherein X₀ is a C₁-C₁₂ perfluorooxyalkyl group comprising one or more than one ethereal oxygen atom; and
(f) (per)fluorodioxoles of formula: 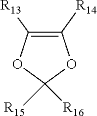
wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms; and
(2) tetrafluoroethylene (TFE)-based elastomeric blocks (A_{TFE}) consisting of a sequence of recurring units, said sequence comprising recurring units derived from TFE and recurring units derived from at least one fluorinated monomer different from TFE, said fluorinated monomer being selected from the group consisting of those of classes (b), (c), (d), (e) as defined above;
at least one thermoplastic block (B) consisting of a sequence of recurring units, said sequence comprising recurring units derived from at least one fluorinated monomer.

3. The method according to claim 2, wherein the elastomeric block (A) is a block (A_{VDF}), consisting of a sequence of recurring units comprising, preferably consisting of:
from 45% to 80% by moles of recurring units derived from vinylidene fluoride (VDF),
from 5% to 50% by moles of recurring units derived from at least one fluorinated monomer different from VDF,
optionally, up to 1.0% by moles of recurring units derived from at least one bis-olefin (OF) of formula:
R_{A}R_{B}═CR_{C}-T-CR_{D}═R_{E}R_{F}
wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, or a (per)fluoropolyoxyalkylene group; and
optionally, up to 30% by moles of recurring units derived from at least one hydrogenated monomer,
with respect to the total moles of recurring units of the sequence of block (A_{VDF}).

4. The method according to claim 1, wherein the block (B) is selected from the group consisting of:
blocks (B_{VDF}) consisting of a sequence of recurring units derived from vinylidene fluoride and optionally from one or more than one additional fluorinated monomer different from VDF, and optionally from a hydrogenated monomer, as above detailed, wherein the amount of recurring units derived from VDF is of 85 to 100% moles, based on the total moles of recurring units of block (B_{VDF});
blocks (B_{TFE}) consisting of a sequence of recurring units derived from tetrafluoroethylene, and optionally from an additional perfluorinated monomer different from TFE, wherein the amount of recurring units derived from TFE is of 75 to 100% moles, based on the total moles of recurring units of block (B);
blocks (B_{E/(C)TFE}) consisting of a sequence of recurring units derived from ethylene and recurring units derived from CTFE and/or TFE, optionally in combination with an additional monomer.

5. The method according to claim 1, wherein the weight ratio between blocks (A) and blocks (B) in polymer (F-TPE) is of 95:5 to 65:35.

6. The method according to claim 1, wherein the crystallinity of block (B) and its weight fraction in the polymer (F-TPE) are such to provide for a heat of fusion of the polymer (F-TPE) of at most 20 J/g, when determined according to ASTM D3418; and wherein polymer (F-TPE) combines thermoplastic and elastomeric character, so as to possess a certain crystallinity, delivering a heat of fusion of at least 2.5 J/g.

7. The method according to claim 1, wherein the polymer (F) is a polymer comprising:
(a′) at least 85% by moles of recurring units derived from vinylidene fluoride (VDF);
(b′) optionally from 0.1 to 15% by moles of recurring units derived from a fluorinated monomer different from VDF; and
(c′) optionally from 0.1 to 5% by moles of recurring units derived from one or more hydrogenated comonomer(s),
all the aforementioned % by moles being referred to the total moles of recurring units of the polymer (F).

8. The method according to claim 7, wherein the polymer (F) is a polymer consisting essentially of:
(a′) at least 85% by moles of recurring units derived from vinylidene fluoride (VDF);
(b′) optionally from 0.1 to 15% by moles of a fluorinated monomer different from VDF; said fluorinated monomer being preferably selected from the group consisting of vinylfluoride (VF₁), chlorotrifluoroethylene (CTFE), hexafluoropropene (HFP), tetrafluoroethylene (TFE), perfluoromethylvinylether (MVE), trifluoroethylene (TrFE) and mixtures thereof, all the aforementioned % by moles being referred to the total moles of recurring units of the polymer (F).

9. The method according to claim 1, wherein polymer (M) is selected from homopolymers of methyl methacrylate and copolymers of methyl methacrylate and of C₂-C₆ alkyl acrylates, wherein the methyl methacrylate content of the copolymers is at least approximately 55% by weight and does not exceed approximately 90% by weight, with respect to the total weight of polymer (M).

10. The method according to claim 1, wherein:
the amount of polymer (F-TPE) in the composition (C) is at least 60% wt and/or is of at most 97% wt, with respect to the total weight of polymer (F), polymer (F-TPE) and polymer (M); and/or
the amount of polymer (F) in the composition (C) is of at least 3% wt; and/or is of at most 50% wt, with respect to the total weight of polymer (F), polymer (F-TPE) and polymer (M); and/or
the amount of polymer (M) is of at most 25% wt, with respect to the total weight of polymer (F), polymer (F-TPE) and polymer (M).

11. The method according to claim 10,
wherein the composition (C) does not comprise any polymer (M) and comprises:
from 50 to 97% wt of polymer (F-TPE) and
from 3 to 50% wt of polymer (F),
wherein % wt is defined with respect to the total weight of polymer (F-TPE) and polymer (F); or
wherein composition (C) comprises:
from 50 to 96% wt of polymer (F-TPE);
from 3 to 45 wt of polymer (F); and
from 1 to 25% wt of polymer (M),
with respect to the total weight of polymer (F), polymer (F-TPE) and polymer (M).

12-14. (canceled)

15. A shaped part made from a fluoropolymer composition (C), said composition (C) comprising:
at least one thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418, and
(ii) at least one thermoplastic block (B) consisting of a sequence of recurring units, said sequence comprising recurring units derived from at least one fluorinated monomer, wherein the crystallinity of said block (B) and its weight fraction in the polymer (F-TPE) are such to provide for a heat of fusion (ΔH_{f}) of the polymer (F-TPE) of at most 20 J/g, when determined according to ASTM D3418, said polymer (F-TPE) being in an amount of at least 50% wt;
at least one at least one thermoplastic vinylidene fluoride (VDF) polymer [polymer (F)] comprising recurring units derived from VDF in an amount of at least 85% moles, with respect to the total moles of recurring units of polymer (F), said polymer (F) possessing a heat of fusion (ΔH_{f}) of the polymer (F-TPE) of at least 25 J/g, when determined according to ASTM D3418; and optionally
at least one methyl methacrylate polymer [polymer (M)] in an amount of at most 25% wt, the % wt being referred to the sum of weights of polymer (F), elastomer (F-TPE) and polymer (M),
wherein said shaped part is a component of at least one of peripheral's, accessories and devices, intended for connection to mobile electronic devices.

16. The shaped part of claim 15, which is selected from the group consisting of:
wrist bands, chest belts and other affixtures intended for securing electronic devices to specific part of human body;
components of signal transmission cables, including cables for transmitting/receiving electric signals generated in acoustic systems or imaging systems;
protective cases designed to receive and hold a portable electronic device; and
components of an earbud, including those intended to be connected to portable electronic devices.

17. The method according to claim 2, wherein at least one elastomeric block (A) is selected from the group consisting of:
(1) vinylidene fluoride (VDF)-based elastomeric blocks (A_{VDF}) consisting of a sequence of recurring units, said sequence comprising recurring units derived from VDF and recurring units derived from at least one fluorinated monomer different from VDF, said fluorinated monomer different from VDF being selected from the group consisting of:
tetrafluoroethylene (TFE); hexafluoropropylene (HFP); vinyl fluoride; trifluoroethylene (TrFE); hexafluoroisobutylene (HFIB); perfluoroalkyl ethylenes of formula CH₂═CH—R_{f1}, wherein R_{f1} is a C₁-C₆ perfluoroalkyl group; chlorotrifluoroethylene (CTFE);
perfluoroalkylvinylethers (PAVE) of formula CF₂═CFOR_{f1}, wherein R_{f1} is —CF₃, —C₂F₅ or —C₃F₇; perfluoromethoxyalkylvinylethers of formula CF₂═CFOCF₂OR_{f2}, wherein R_{f2} is a C₁-C₃ perfluoro(oxy)alkyl group; and (per)fluorodioxoles of formula: 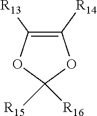
wherein each of R_{f3}, R_{f4}, R_{f5} and R_{f6}, equal to or different from each other, is independently —F, —CF₃, —C₂F₅, —C₃F₇, —OCF₃ or —OCF₂CF₂OCF₃; and
(2) tetrafluoroethylene (TFE)-based elastomeric blocks (A_{TFE}) consisting of a sequence of recurring units, said sequence comprising recurring units derived from TFE and recurring units derived from at least one fluorinated monomer different from TFE, said fluorinated monomer being selected from the group consisting of vinyl fluoride; trifluoroethylene (TrFE); hexafluoroisobutylene (HFIB); perfluoroalkyl ethylenes of formula CH₂═CH—R_{f1}, wherein R_{f1} is a C₁-C₆ perfluoroalkyl group; chlorotrifluoroethylene (CTFE);
perfluoroalkylvinylethers (PAVE) of formula CF₂═CFOR_{f1}, wherein R_{f1} is —CF₃, —C₂F₅ or —C₃F₇; and perfluoromethoxyalkylvinylethers of formula CF₂═CFOCF₂OR_{f2}, wherein R_{f2} is a C₁-C₃ perfluoro(oxy)alkyl group.

18. The method according to claim 6, wherein the crystallinity of block (B) and its weight fraction in the polymer (F-TPE) are such to provide for a heat of fusion of the polymer (F-TPE) of at most 18 J/g, when determined according to ASTM D3418; and wherein polymer (F-TPE) combines thermoplastic and elastomeric character, so as to possess a certain crystallinity, delivering a heat of fusion of at least 3.0 J/g.

19. The method according to claim 10, wherein:
the amount of polymer (F-TPE) in the composition (C) is at least 70% wt; and/or is of at most 94% wt, with respect to the total weight of polymer (F), polymer (F-TPE) and polymer (M); and/or
the amount of polymer (F) in the composition (C) is of at least 6% wt; and/or is of at most 30% wt, with respect to the total weight of polymer (F), polymer (F-TPE) and polymer (M); and/or
the amount of polymer (M) is of at most 15% wt, with respect to the total weight of polymer (F), polymer (F-TPE) and polymer (M).

20. The method according to claim 11,
wherein the composition (C) does not comprise any polymer (M) and comprises:
from 70 to 94% wt of polymer (F-TPE) and
from 6 to 30% wt of polymer (F),
wherein % wt is defined with respect to the total weight of polymer (F-TPE) and polymer (F); or
wherein composition (C) comprises:
from 70 to 89% wt of polymer (F-TPE);
from 6 to 25% wt of polymer (F); and
from 5 to 15 wt of polymer (M),
with respect to the total weight of polymer (F), polymer (F-TPE) and polymer (M).

21. A fluoropolymer composition [composition (C)], said composition comprising:
at least one thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418, and
(ii) at least one thermoplastic block (B) consisting of a sequence of recurring units, said sequence comprising recurring units derived from at least one fluorinated monomer, wherein the crystallinity of said block (B) and its weight fraction in the polymer (F-TPE) are such to provide for a heat of fusion (ΔH_{f}) of the polymer (F-TPE) of at most 20 J/g, when determined according to ASTM D3418, said polymer (F-TPE) being in an amount of at least 50% wt;
at least one at least one thermoplastic vinylidene fluoride (VDF) polymer [polymer (F)] comprising recurring units derived from VDF in an amount of at least 85% moles, with respect to the total moles of recurring units of polymer (F), said polymer (F) possessing a heat of fusion (ΔH_{f}) of the polymer (F-TPE) of at least 25 J/g, when determined according to ASTM D3418; and
at least one methyl methacrylate polymer [polymer (M)] in an amount of at most 25% wt, the % wt being referred to the sum of weights of polymer (F), elastomer (F-TPE) and polymer (M).

22. A method of making the composition (C), according to claim 19, wherein the method includes at least one step of mixing polymer (F), polymer (F-TPE), and polymer (M).

23. A method of making a shaped part, said method comprising moulding a composition (C) according to claim 19, wherein moulding is carried out by at least one of compression moulding, extrusion moulding, injection moulding, and transfer moulding.
